(19) United States
(12) Patent Application Publication
(10) Pub. No.: US 2012/0310983 A1
(43) Pub. Date: Dec. 6, 2012

(54) EXECUTABLE IDENTITY BASED FILE ACCESS

(76) Inventors: Hemant Mittal, Morgan Hill, CA (US); Shankar Raman, Bangalore (IN)

(21) Appl. No.: 13/577,174

(22) PCT Filed: Feb. 11, 2010
(86) PCT No.: PCT/US10/23895

§ 371 Date: Aug. 3, 2012

(51) Int. Cl. G06F 17/30

(52) U.S. Cl. 707/785; 707/E17.005

(57) ABSTRACT

In examples of the present invention, an executable seeks to access a data file. An executable identity based access control list is accessed to determine whether the executable should be allowed to access the data tile.

### BACKGROUND

In the art of computing, it may be desirable to restrict access to a data file. One method known in the art is user based file access control. An executable executes with the access privileges associated with a particular user or group of users, and a data file may be configured so that only executables executing with the credentials of an authorized user or group of users may access the data file. For example, if an executable is executing with the credentials of User A, and the data file is configured to only allow access to executables executing with the credentials of User B, the executable will not be allowed to access the data file. Similarly, user based file access control may be applied to a class of users. For example, Users A, B, and C may be part of a class of ordinary users, and a data file may be configured to only allow access to users that are part of an Administrator class.

Another method known in the art is to only allow an executable to execute if the integrity of the executable is verified using a certificate. The executable is signed with a certificate issued by a Certificate Authority, and the signature of the executable is verified against the certificate before the executable is allowed to execute.

### BRIEF DESCRIPTION OF THE DRAWINGS

The Figures depict embodiments, implementations, and configurations of the invention, and not the invention itself.

FIG. 1 is a simplified block diagram of a computing environment that illustrates examples of the present invention.

FIG. 2 is a block diagram of a computer system in which examples of the present invention may be deployed.

FIG. 3 is a block diagram showing a file system module, in accordance with examples of the present invention.

FIG. 4 shows an executable, in accordance with examples of the present invention.

FIG. 5 shows a data file and policy metadata associated with the data file, in accordance with examples of the present invention.

FIG. 6 is a flowchart that illustrates actions taken by a signature tool, in accordance with examples of the present invention.

FIG. 7 is a flowchart that illustrates actions taken by an access policy to accordance with examples of the present invention.

FIG. 8 is a flowchart that illustrates actions taken by a file system module and policy enforcement manager, in accordance with examples of the present invention.

### DETAILED DESCRIPTION

In the foregoing description, numerous details are set forth to provide an understanding of the present invention. However, it will be understood by those skilled in the art that the present invention may be practiced without these details. While the invention has been disclosed with respect to a limited number of examples, implementations, and embodiments, those skilled in the art will appreciate numerous modifications and variations therefrom. It is intended that the appended claims cover such modifications and variations as fall within the true spirit and scope of the invention.

Examples of the present invention provide executable identity based file access control to determine whether a particular executable is allowed to access a particular data file. in essence, a “whitelist” is associated with each data file that defines which executables are allowed to access the data file. As discussed above in the Background section, it is known in the art to provide user identity based file access control such that only executables operating with proper user credentials may access a data file. It is also known it use digital certificates to determine whether a particular executable may be allowed to execute. However, these mechanisms do not allow data file access to be restricted based on the identity of the executable.

Consider an on-line retailer that operates a web-based storefront. Typically, a suite of executables are used to operate the storefront, including executables for displaying products offered for sale, entering and displaying customer reviews, taking orders, initiating credit card transactions, calculating shipping costs for various shipping options, and the like. These executables may be provided by a variety of vendors. Furthermore, assume that the on-line retailer maintains a customer database that includes customer user IDs, shipping addresses, email addresses, phone numbers, and credit card numbers. If all executables in the suite are executing with the same user credentials, each executable will have access to the customer database. Accordingly, if malicious code is introduced into any of the executables, that malicious code may access the customer database, and the information contained therein may be comprised. Using examples of the invention, access to the customer database can be limited to the executables that process orders and initiate credit card transactions. These executables may be provided by vendors that are inherently more trustworthy than the executables that perform other functions, such as maintaining customer reviews. Accordingly, examples of the present invention enhance security for the on-line vendor and the vendor's customers.

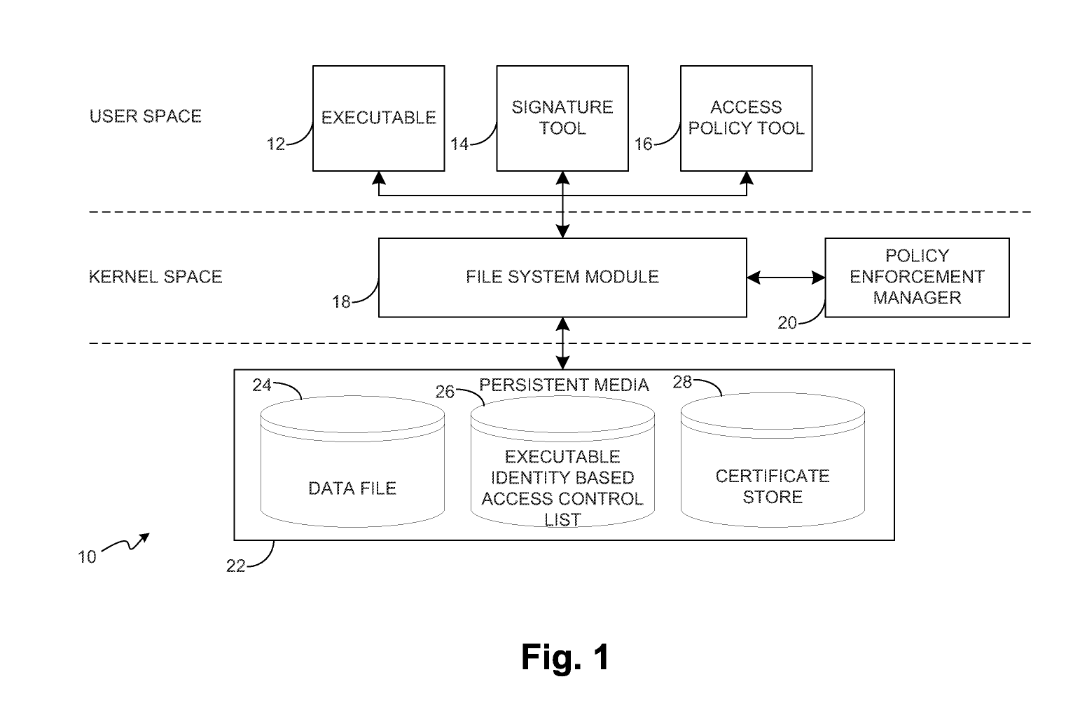

FIG. 1 is a simplified block diagram of a computing environment 10 that illustrates examples of the present invention. Computing environment 10 includes executable 12, signature tool 14, and access policy tool 16 (all operating in user space). Computing environment 10 also includes file system module 18 and policy enforcement manager 20 (both of which operate in kernel space), and persistent media 22, Persistent media 22 stores data file 24, executable identity based access control list 26, and certificate store 28.

Certificates are stored in certificate store 28. Certificates are used to validate integrity, and a typical certificate includes the following items:
Serial Number: Used to uniquely identify the certificate.
Subject: The person, or entity identified,
Signature Algorithm: The algorithm used to create the signature.
Issuer: The entity that verified the information and issued the certificate.
Valid-From: The date the certificate is first valid from.
Valid-To: The expiration date.
Key-Usage: Purpose of the public key.
Public Key: The public key to verify a signature from the named subject.
Thumbprint Algorithm: The algorithm used to hash the certificate.
Thumbprint: The hash itself to ensure that the certificate has not been tampered with.

Note that certificates include public keys. A corresponding private key is associated with each certificate, and is kept private. The process of signing an object, such as an executable, comprises performing a function on the object using a function such as a 256-bit SHA2 hash function, The result of the function is encrypted with the private key to form the signature, and the signature is stored in a place where it can later be retrieved by one seeking to verify the integrity of the object. Often the signature is stored with the object.

The process of verifying the object comprises accessing the certificate to get the public key stored with the certificate, and performing the same function is performed on the object. The signature is decrypted with the public key and compared to the result of the function. A match verifies the integrity of the object, and a mismatch indicates that the object (or the signature or the certificate) has been altered, and therefore the integrity of the object cannot be verified.

In an enterprise computing environment, typically a user is defined to act as an Information Technology (IT) Security Officer. The Security Officer defines various policies relating to IT security. The Security Officer uses signature tool 14 to digitally sign an executable using a private key, and the certificate associated with the private key is stored in certificate store 28. The Security Officer also uses access policy toot 16 to define which executables are allowed to access various data files. The stored policy is also protected by a certificate. With reference to FIG. 1, signature tool 14 is used to digitally sign executable 12, and access policy tool 16 is used to register executable 12 in executable identity based access control list 26, thereby allowing executable 12 to access data file 24.

When executable 12 is executing and seeks to open an I/O stream to data file 24, executable 12 passes an I/O request to file system module 18, In turn, file system module 18 passes a reference of executable 12 and a reference of data file 24 to policy in enforcement manager 20, Policy enforcement manager 20 accesses executable identity based access control list 26 and retrieves executable identity based file access policies for data file 24. Accordingly, policy enforcement manager 20 determines whether access should be permitted, and verifies the integrity of executable 12 and executable identity based access control list 26. If access is allowed and the integrity of executable 12 and executable identity based access control list 26 are verified, policy enforcement manager 20 signals file system module 18 to service the I/O request and open the I/O stream. Otherwise, policy enforcement manager 20 signals file system module 18 to deny the I/O request.

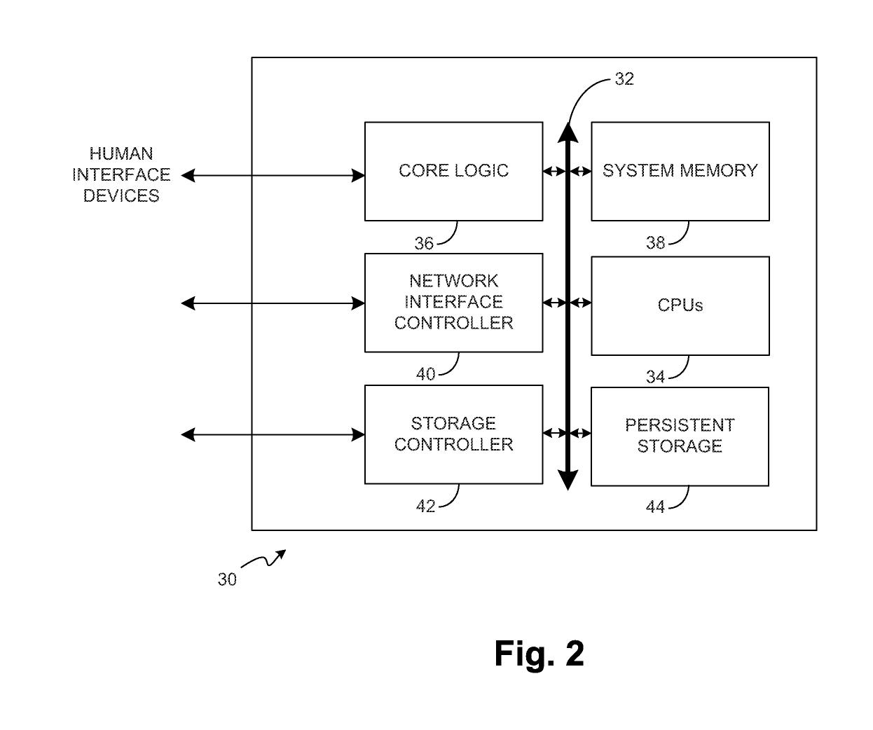

Before discussing the invention in greater detail, first consider a typical computer system in which examples of the invention may be deployed. FIG. 2 is a block diagram of computer system 30. Computer system 30 includes a bus 32. Coupled to bus 32 are one or more CPUs 34, core logic 36, system memory 38, network interface controller 40, storage controller 42, and persistent storage 44.

Although bus 32 is shown generically as a single bus, those skilled in the art will recognize that typically a variety of busses and fabrics are used to connect the components shown in FIG. 2. CPUs 34 may represent a single CPU, multiple CPUs in individual integrated circuit (IC) packages, multiple CPU cores in a discrete IC package, or any combination of these elements. Core logic 36 represents the core logic that couples CPUs 34, system memory network interface controller 40, storage controller 42, and persistent storage 44. In some architectures, core logic 36 includes a Northbridge and a Southbridge. However, other architectures are known in the art, For example, in sonic architectures, the memory controller is provided in the CPU.

For the purposes of describing examples of the present invention, core logic 36 also includes other components found in a typical computer system, such as firmware and I/O components, disk controllers for local persistent storage, USB ports, video controllers coupled to monitors, keyboards, mice, and the like. To illustrate generically devices such as monitors, keyboards, mice, trackballs, touchpads, speakers, and the like, core logic 36 is shown as being connected to human interface devices. Note that such human interface devices may also be provided remotely via, network interface controller 40. In a server, some of these components may not be utilized.

Persistent storage 44 represents storage used to store local copies of the operating system, executables, and data. Persistent storage 44 may represent devices (and appropriate corresponding media) such as hard disk drives, solid state drives, tape drives, optical drives, floppy drives, and the like. Alternatively, persistent storage may be provided external to computer 30 via storage controller 42 or network interface controller 40. For example, storage controller 42 may be coupled to a storage area network (SAN), which in turn is coupled to a disk array subsystem. Similarly, network interface controller 40 may be coupled to a local area. network (LAN) or wide area network (WAN), which in turn is coupled to network attached storage.

FIG. 1 shows persistent media 22. With reference to FIG. 2, persistent media. 22 may be implemented by persistent storage 44. However, persistent media 22 may also be implemented by media connected to storage controller 42 or network interface controller 40.

Also note that executable 12, signature tool 14, access policy tool 16, file system module 18, policy enforcement manager 20, data. file 24, executable identity based access control list 26, and certificate store 28, all of FIG. 1, may exist at any point in time, either as a single copy or multiple copies, and in whole or in portions, on persistent storage 44, media. connected to network interface controller 40, media connected to storage controller 42, within system memory 38, or within cache memories of CPUs 34 or core logic 36.

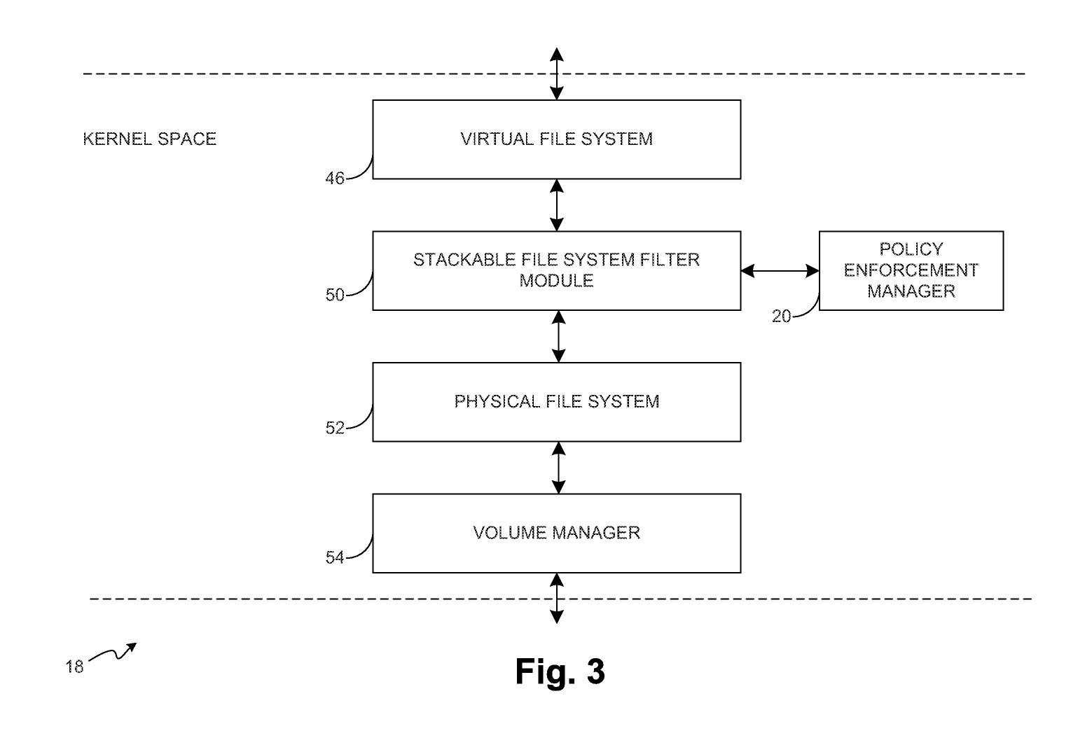

In FIG. 1, file system module 18 is depicted as a single block. FIG. 3 is a block diagram showing file system module 18 in greater detail. In FIG. 3, file system module 18 includes virtual file system 46, stackable file system filter module 50, physical file system 52, and volume manager 54. Also shown in FIG. 3 is policy enforcement manager 20, which is coupled to stackable file system filter module 50.

Virtual file system 46 provides access to executables operating in user space, as shown in FIG. 1. For I/O streams that have been opened, virtual file system 46 also caches open files.

Stackable file system filter module 50 is coupled to policy enforcement manager 20. Stackable file system filter module 50 traps requests and determines, via communication with policy enforcement manager 20, whether the executable initiating the I/O request is authorized to access the data file that is the subject of the I/O request. Note that by providing a separate stackable module, examples of the present invention can be provided in present file system stacks without requiring significant alteration of the other modules in the file system stack.

Physical file system 52 manages access to physical files. The files may be present on local persistent storage, or storage coupled by a SAN, LAN, or WAN, as discussed above. Finally, volume manager 54 manages disk volumes found on persistent media. For example, volume manager 54 may manage multiple partitions on a single physical disk drive, mirrored volumes that mirror data to two or more physical disk drives, or other type of volumes known in the art.

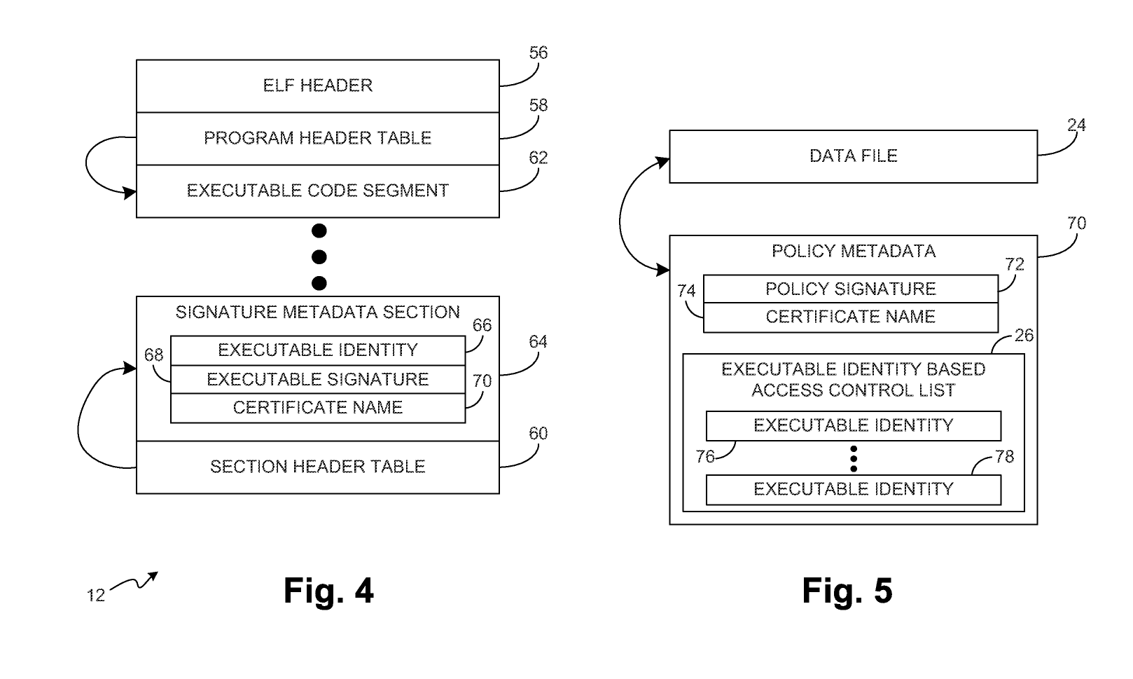

FIG. 4 shows executable 12 of FIG. 1, in accordance with an example of the present invention, in a file adhering to the Executable and Linkable Format (ELF). ELF is very flexible and extensible, and allows metadata to be stored with the executable. ELF is used by a many Unix and Unix-like operating systems, including the HP-UX operating system, which is a product of Hewlett-Packard Company. Other executable file formats used by other operating systems are also capable of storing metadata, and may be appropriate for use with examples of the present invention.

If examples of the present invention are used with operating systems having executable formats that are not capable of storing metadata, the metadata shown in FIG. 4 may be provide elsewhere, such as a separate database file or a named stream file. As discussed below with reference to FIG. 5, these mechanisms may also be used to associate metadata with data file 24. Also note that some executable files may not be implemented using ELF. For example, a script file is an executable file, but the script file itself may be a simple text file. Accordingly, a named stream file can be associated with a script file to store the information discussed below with reference to FIG. 4.

Executable 12 includes an ELF header 56 that contains information such as:
ELF Identification
Object File Type
Machine Type
Object File Version
Entry Point Address
Program Header Offset
Section Header Offset
Processor-Specific Flags
ELF Header Size
Size of Program Header Entry
Number of Program Header Entries
Size of Section Header Entry
Number of Section Header Entries
Section Name String Table Index

Note that the list above includes a program header offset that identifies the location of the program header table. The program header table identifies segments containing executable code and data used at runtime, In FIG. 4, program header table 58 indentifies executable code segment 62. It is common to have additional segments, and additional segments are represented by the three dots below executable code segment 62.

Also note that the list above includes a section header offset, which identifies the location of the section header table. The section header table identifies sections containing metadata associated with the executable, such as data related to linking and relocation. Additional sections may be defined, and in accordance with examples of the present invention, a signature metadata section 64 is defined. Section header table 60 includes an entry that identifies signature metadata section 64, Note that additional sections are represented by the three dots above signature metadata section 64.

Signature metadata section 64 includes executable identity field 66, executable signature field 68, and certificate name field 70. Executable identity field 66 stores an executable identity that uniquely identifies executable 12. For example, the executable identity may be generated by applying a hash function to the segments identified by program header table 58, such as executable segment 62. Certificate name field 70 stores a certificate name that identifies a certificate stored in certificate store 28 of FIG. 1. The certificate includes a public key, as discussed above. Executable signature field 68 stores an executable signature generated by applying the private key associated with the certificate to the executable identity. Executable signature 68 may be created by signature tool 14 of FIG. 1, as will be described in greater detail

FIG. 5 shows data file 24 of FIG. 1 and policy metadata 70 associated with data file 24. Many operating systems support mechanisms for associating metadata with a data file. For example, many Unix and Unix-like operating systems support extended file attributes, which can be used to store policy metadata. Other operating systems support file forks, which allow an additional data stream to be associated with a file. For example, NITS file systems, which are used in certain versions of Microsoft Windows® operating systems, support Alternate Data Streams. Certain versions of HP-UX operating systems, which are products of Hewlett-Packard Company, support separate named stream files that are linked with the data file. Note that if a file system is used that does not support associating metadata with a data file, examples of the present invention may still be implemented by providing a database that uniquely identifies the data file and includes the other information shown in FIG. 5.

As mentioned above, data file 24 is associated with policy metadata 70. Policy metadata 70 includes policy signature field 72, certificate name field 74, and executable identity based access control list 26 (which is also shown in FIG. 1). Certificate name field 74 stores a certificate name that identifies a certificate stored in certificate store 28. The certificate includes a public key as discussed above. Policy signature field 72 stores a policy signature generated by first applying a hash function to executable identity based access control list 26, and then digitally signing the result with the private key associated with the certificate. Generation of the policy signature will be described in greater detail below. Note that the policy signature protects the integrity of executable identity based access control list 26 by allowing detection of any unauthorized or unintended changes to executable identity based access control list 26.

Executable identity based access control list 26 stores the executable identity of each executable that is authorized to access data file 24, such as the executable identities stored in fields 76 and 78. As mentioned above, the executable identities may be generated by applying a hash function to the segments identified by program header table 58, such as executable segment 62. Executable identity based access control list 26 may be populated by access policy tool 16, as will be discussed in greater detail below.

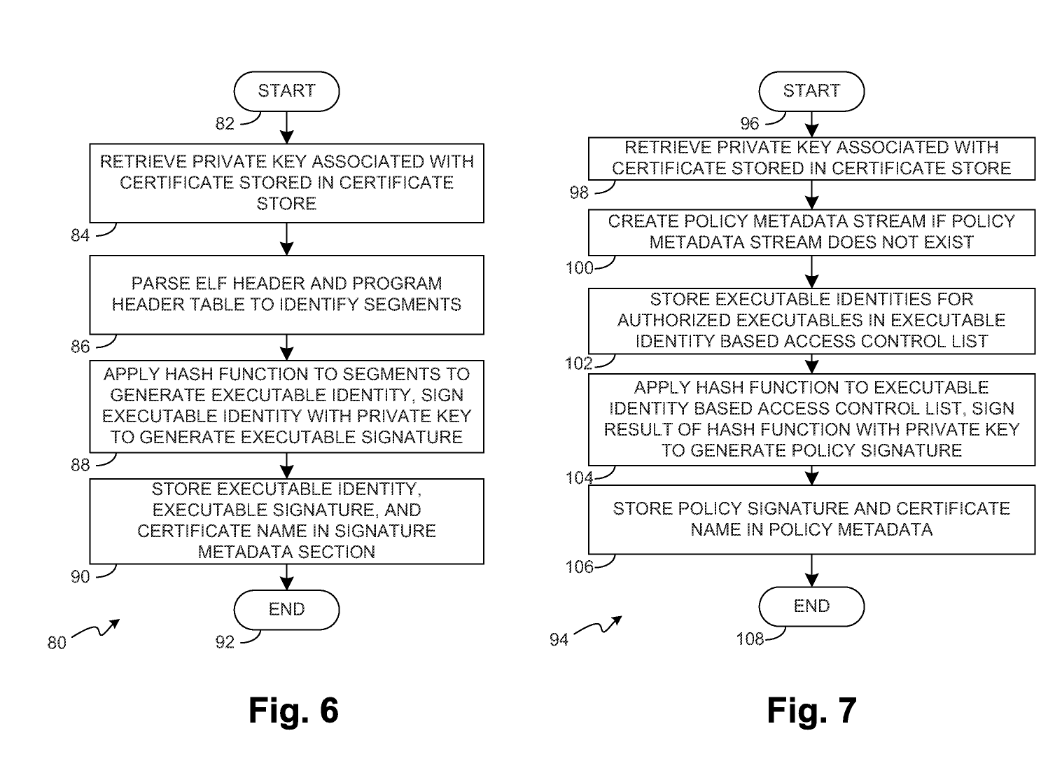

FIG. 6 is a flowchart 80 that illustrates the actions taken by signature tool 14 of FIG. 1. Signature tool 14 is used to sign executables, such as executable 12 of FIG. 1. Typically, certificate store 28 of FIG. 1 is only accessible by signature tool 14 and access policy tool 16 in user space, and modules operating in kernel space, such as policy enforcement manager 20 of FIG. 1.

Flowchart 80 starts at Start block 82, and control passes to block 84. At block 84, the private key associated with the certificate stored in certificate store 28 is retrieved. Note that the private key is kept private, and will typically be provided by the Security Officer. Typically certificates and the associated keys may be obtained from a Certificate Authority, such as VeriSign, Inc. Control passes to block 86.

At block 86, ELF header 56 and program header table 58 of FIG. 4 are parsed to identify the segments that comprise the executable and data portions of executable 12, such as executable code segment 62 of FIG. 4. Control passes to block 88.

At block 88, using the private key retrieved in block 84, a hash function is applied to the segments identified in block 86 to form the executable identity. In one example, a one way 256-bit SHA2 hash is performed. The executable identity is signed with the private key to form the executable signature. Control passes to block 90.

At block 90, the executable identity, executable signature, and certificate name are stored in signature metadata section 64 of FIG. 4. Control passes to End block 92, where the flowchart ends. At this point, executable 12 has been digitally signed and is ready to participate in executable identity based file access, in accordance with examples of the present invention.

FIG. 7 is a flowchart 94 showing actions taken by access policy tool 16 of FIG. 1. Typically, a Security Officer will use access policy tool 16 to define the executables that will be allowed to access a particular data file. Flowchart 96 begins at Start block 96, and control passes to block 98. At block 98, the private key associated with the certificate stored in certificate store 28 is retrieved, and control passes to block 100. As discussed above, the private key may be provided by the Security Officer.

If access policy tool 16 is being used to define data file access policies fir a data file for which such policies were not defined previously, policy metadata 70 of FIG. 5 may not be present. Accordingly, block 100 creates the policy metadata stream shown in FIG. 5 if the policy metadata stream does not exist. Control passes to block 102.

At block 102, the executable identities for authorized executables are stored in the executable identity based access control list (list 26 in FIGS. 1 and 5). Control passes to block 104.

At block 104, a hash function is applied to executable identity based access control list 26, and the result is signed using the private key retrieved in block 98 to generate the policy signature. In one example, the hash function is a one-way 256-bit SHA2 hash function. Control passes to block 106.

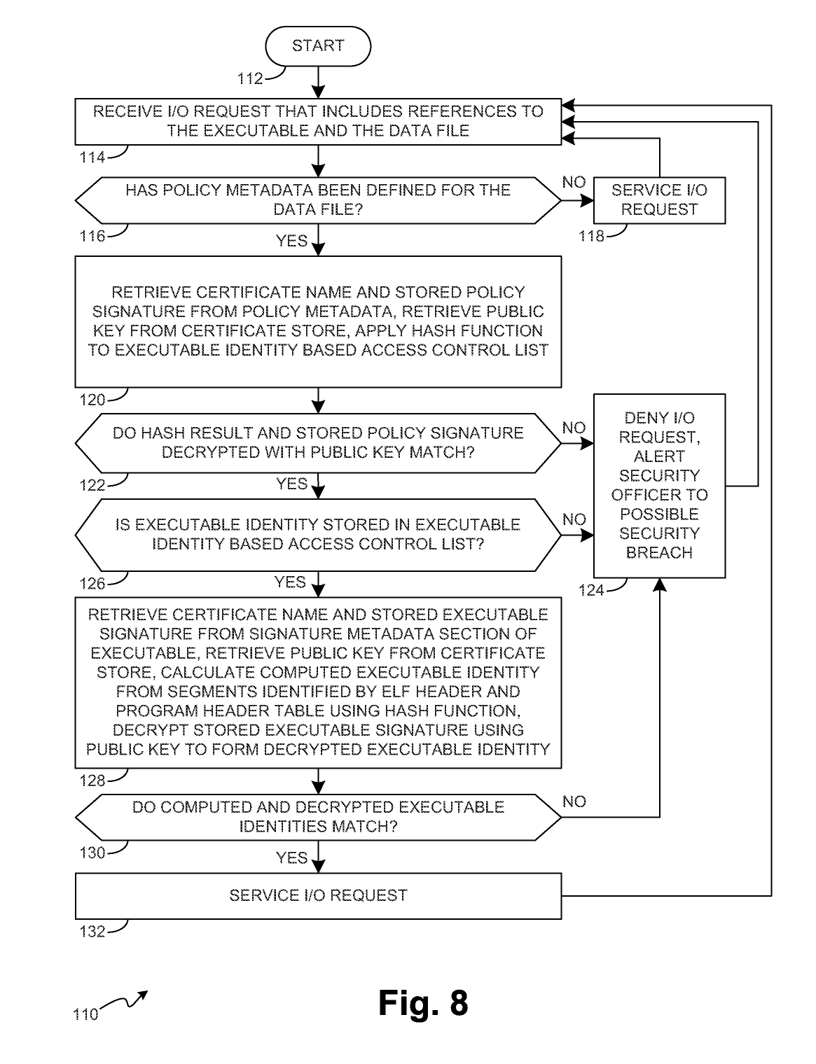

At block 106, the policy signature and the certificate name are stored in the policy metadata, as shown in FIG. 5. At this point, one or more executables are authorized to access the data file, as will be discussed below with reference to FIG. 8.

FIG. 8 shows a flowchart 110 that illustrates the actions taken by file system module 18 and policy enforcement manager 20 of FIG. 1, If file system module 18 is implemented as shown in FIG. 3, the actions are performed by stackable file system filter module 50 and policy enforcement manager 20. Flowchart 110 begins at Start block 112, and control passes to block 114.

At block 114, the file system module receives an I/O request from the executable, such as executable 112 of FIGS. 1 and 4. The I/O request includes references to the executable and the data file, such as data file 24 of FIGS. 1 and 5. Control passes to decision block 116.

Decision block 116 determines whether policy metadata has been defined for the data file. Many data files in computing environment 10 of FIG. 1 may not have access restricted to authorized executables, in which case, it is desirable to service the I/O request. Accordingly, if policy metadata has not been defined for the data file, the NO branch is taken to block 118. Block 118 services the I/O request, and control passes back to block 114 to await the next I/O request. If policy metadata has been defined for the data file, the YES branch is taken to block 120.

At block 120, the certificate name and the stored policy signature are retrieved from the policy metadata, The certificate name is used to retrieve the proper public key from certificate store 28. The hash function is applied to the executable identity based access control list. Control passes to decision block 122.

At decision block 122, the hash result is compared to the policy signature decrypted with the public key. if they are different, then the executable identity based access control list has been altered. Note that the alteration may indicate a security breach, since the hash result and decrypted policy signature should match. If they do not match, the NO branch is taken to block 124. At block 124, the I/O request is denied, and the Security Officer is alerted to the possibility that there has been a security breach. Control then passes back to block 114 to wan for the next I/O request. if they do match, then the integrity of the executable identity based access control list has been verified and the YES branch is taken to decision block 126.

Decision block 126 determines whether the identity of the executable has been stored in the executable identity based access control list. If the executable identity is not present, the executable is not authorized to access the data file, and the NO branch is taken to block 124. As discussed above, block 124 will deny the I/O request and alert the Security Office that there may be a possible security breach. However, the potential security breach may be less severe than the possible breach detected at block 122. At block 122, it was determined that the policy metadata was subjected to an unauthorized alteration. However, the fact that an executable is not authorized to access a data file may have a more innocent cause, such as a user accidently trying to open the data file, Accordingly, it may be desirable to bypass the alert to the Security Officer, and in the alternative, log the failed access attempt. Control then passes back to block 114 to wait for the next I/O request. If the executable identity is present in the executable identity based access control list, the YES branch is taken to block 128.

At block 128, the certificate name and the stored executable signature are retrieved from the signature metadata section of the executable, and the public key identified by the certificate name is retrieved from the certificate store. A computed executable identity is calculated from the segments identified by the ELF header and the program header table (shown in FIG. 4) using the hash function, and the stored executable signature is decrypted with the public key to form a decrypted executable identity. Control then passes to decision block 130.

Decision block 130 determines whether the stored executable identity and the decrypted executable identity match. If they do not match, than there has been a possible security breach since the executable may have been subjected to a malicious alteration. Accordingly, the NO branch is taken to block 124, where the I/O request is denied and the Security Officer is alerted, as discussed above. Control then passes to block 114 to wait for the next I/O request.

If the computed and decrypted executable identities do match, then the I/O request has been authorized. Accordingly, the YES branch is taken to block 132, which services the I/O request, and control is passed back to block 114 to wait for the next I/O request.

In the foregoing description, numerous details are set forth to provide an understanding of the present invention. However, it will be understood by those skilled in the art that the present invention may be practiced without these details. While the invention has been disclosed with respect to a limited number of examples, implementations, and embodiments, those skilled in the art will appreciate numerous modifications and variations therefrom. It is intended that the appended claims cover such modifications and variations as fall within the true spirit and scope of the invention.

What is claimed is:

1. A method (110) of allowing an executable to access a data file comprising:
initiating (114) a file access request from the executable (12) to the data file (24);
accessing (126) an executable identity based access control list (26) to determine (126) whether the executable (12) is allowed to access the data file (24);
allowing (132) the executable (12) to access the data file (24) if the executable (12) is allowed to access the data file (24); and
prohibiting (124) the executable (12) from accessing the data file (24) if the executable (12) is not allowed to access the data file (24).

2. The method (110) of claim 1 wherein accessing (126) the executable identity based access control list (26) includes verifying executable integrity (128, 130) by comparing (130) a computed executable identity to an executable identity formed by decrypting (128) a stored executable signature with a public key stored in a certificate store (28).

3. The method (110) of claim 2 wherein the executable identity based control list (26) is stored in policy metadata (70) associated with the data file (24), with the executable identity based access control list (26) storing an executable identities (76, 78) that identify the executable (12).

4. The method (110) of claim 3 wherein a stored policy signature (72) is associated with the executable identity based access control list (26), and executable identity based access policies are validated by comparing (122) the stored policy signature (72) decrypted (122) with a public key stored in the certificate store (28) with results of a hash function applied (120) to the executable identity based access control list (26).

5. The method of claim 2 and further comprising:
creating (80) the stored executable signature (68) for the executable (12); and
defining (94) executable identity based tile access policies for the data file (24) by storing the executable identity (66) in the executable identity based access control list (26).

6. Readable media (44) having computer executable program segments stored thereon, the computer executable program segments including:
a policy enforcement manager (20) for determining whether an executable (12) is allowed to access a data file (24) by accessing an executable identity based access control list (26); and
a file system module (18) for servicing a file access request from the executable (12) to the data. file (24), wherein the file system module (18) communicates with the policy enforcement manager (20) to determine whether the executable (12) is allowed to access the data file (24), and services the file access request if access is allowed, and denies the file access request if access is prohibited.

7. The readable media (44) of claim 6 wherein the policy enforcement manager (20) verifies integrity of the executable (12) by comparing a stored executable signature (68) decrypted by a public key from a certificate store (28) to a computed executable identity formed by applying a hash function to the executable (12).

8. The readable media (44) of claim 7 and further comprising:
a signature tool (14) that calculates the stored executable signature (68) by applying the hash function to form an executable identity (66), and encrypting the execution identity (66) with a private key associated with a certificate in a certificate store (28).

9. The readable media (44) of claim 7 wherein the executable identity based access control list (26) is stored in policy metadata (70) associated with the data file (24), with the executable identity based access control list (26) storing an executable identity (76, 78) that identifies the executable (12), and wherein the policy metadata (70) also includes a stored policy signature (72), and executable identity based file access policies are validated by comparing the stored policy signature (72) decrypted with a public key from the certificate store (28) with a result of applying a hash function to the executable identity based access control list (26).

10. The readable media of claim 9 and further comprising:
an access policy tool (18) for defining executable identity based file access policies for the data file (24) by storing the executable identity (66) in the executable identity based access control list (26),

11. A computing environment (10, 30) comprising:
a CPU (34);
persistent media (22) coupled to the CPU (34), the persistent media (22) including a data file (24) and an executable identity based access control list (26);
memory (38) coupled to the CPU (34), wherein an executable (12), a file system module (18) and a policy enforcement manager (20) are executed by the CPU (34) from the memory (38), and wherein the executable (12) initiates an I/O request to the file system module (18) to access the data file (24), the file system module (18) cooperates with the policy enforcement manger (20) to access the executable identity based access control list (26) to determine whether the executable (12) is allowed to access the data file (24), and the file system module (18) allows the executable (12) to access the data file (24) if the executable (12) is allowed to access the data file (24), and prohibits the executable (12) from accessing the data file (24) if the executable (12) is not allowed to access the data file (24).

12. The computing environment (10, 30) of claim 11 wherein the persistent media (22) includes a certificate store (28), and integrity of the executable (12) is verified by comparing a computed executable identity to an executable identity formed by decrypting a stored executable signature (68) with a public key stored in the certificate store (28).

13. The computing environment (10, 30) of claim 12 wherein the executable identity based access control list (26) is stored in policy metadata (70) associated with the data. file (24), with the executable identity based access control list (26) storing an executable identity (76, 78) that identifies the executable (12).

14. The computing environment (10, 30) of claim 13 wherein a stored policy signature (72) is associated with the executable identity based access control list (26), and executable identity based access policies are validated by comparing the stored policy signature (72) decrypted with a public key stored in the certificate store (28) with results of a hash function applied to the executable identity based access control list (26).

15. The computing environment (10, 30) of claim 12 wherein a signature tool (14) and an access policy tool (16) are also executed by the CPU (34) from the memory (38), with the signature tool (14) creating the stored executable signature (68) for the executable (12), and the access policy tool (16) defining executable identity based file access policies for the data file (24) by storing the executable identity (66) in the executable identity based access control list (26).
